(19) United States
(12) Patent Application Publication
(10) Pub. No.: US 2011/0084660 A1
(43) Pub. Date: Apr. 14, 2011

(54) WALL CHARGER WITH REMOVABLE CHARGER

(75) Inventor: Christopher McSweyn, Oxnard, CA (US)

(73) Assignee: SCOSCHE INDUSTRIES, INC., Oxnard, CA (US)

(21) Appl. No.: 12/722,018

(22) Filed: Mar. 11, 2010

Related U.S. Application Data
(60) Provisional application No. 61/249,933, filed on Oct. 8, 2009.

(51) Int. Cl. H02J 7/02

(52) U.S. Cl. 320/111

(57) ABSTRACT

A wall charger includes a body that has at least one prong configured to be connected to an alternating current (AC) power source, a Universal Serial Bus (USB) connection port, the USB connection port being electrically connected to the at least one prong, and a docking port, and a removable charger, wherein the docking port is configured to slidably receive the movable charger, the docking port being electrically connected to the at least one prong. In another aspect of the disclosure, the removable charger comprises a second USB connection port electrically connected to the at least one prong. In yet another aspect of the disclosure, a method for charging at least one portable electronic device with the wall charger includes connecting the at least one prong to an AC power source and connecting a portable electronic device (PED) to the USB connection port.

### BACKGROUND

1. Field

The present disclosure relates to a wall charger and, more particularly, to a dual Universal Serial Bus (USB) wall charger with a removable USB 12V charger.

2. Description of Related Art

Separate USB AC wall chargers, USB DC 12V chargers, and 12V AC wall chargers are known in the art. However, there is a need for a more compact travel charger that provides USB AC wall, USB DC 12V, and 12V AC wall charging capabilities.

### SUMMARY

In one aspect of the disclosure, a wall charger includes a body that has at least one prong configured to be connected to an alternating current (AC) power source, a Universal Serial Bus (USB) connection port, the USB connection port being electrically connected to the at least one prong, and a docking port, and a removable charger, wherein the docking port is configured to slidably receive the removable charger, the docking port being electrically connected to the at least one prong.

In another aspect of the disclosure, the removable charger comprises a second USB connection port configured to receive a USB plug, the second USB connection port being electrically connected to the at least one prong.

In yet another aspect of the disclosure, a method for charging at least one portable electronic device with a wall charger comprising a body having at least one prong configured to be connected to an AC power source, a USB connection port, and a docking port, the USB connection port and the docking port being electrically connected to the at least one prong, includes connecting the at least one prong to an AC power source and connecting a portable electronic device (PED) to the USB connection port.

Another aspect of the disclosure includes a method for supplying power to charge at least one PED through a USB port by configuring a wall charger to connect to an AC power source and providing an electrical connection from the AC power source to a USB connection port and a second USB connection port in a removable charger.

It is understood that other aspects of a wall charger will become readily apparent to those skilled in the art from the following detailed description, wherein it is shown and described only exemplary configurations of a wall charger. As will be realized, the invention includes other and different aspects of a wall charger and the various details presented throughout this disclosure are capable of modification in various other respects, all without departing from the spirit and scope of the invention. Accordingly, the drawings and the detailed description are to be regarded as illustrative in nature and not as restrictive.

### BRIEF DESCRIPTION OF THE DRAWINGS

FIG. 1 is a perspective view of a wall charger;

FIG. 2 is another perspective view of the wall charger;

FIG. 3 is a side view of the wall charger;

FIG. 4 is another side view of the wall charger;

FIG. 5 is a front view of the wall charger;

FIG. 6 is a bottom view of the wall charger;

FIG. 7 is a top view of the wall charger;

FIG. 8 is a perspective view showing the insertion/removal of the USB 12V charger into the 12V port of the wall charger;

FIG. 9 is a top view showing the insertion/removal of the USB 12V charger into the 12V port of the wall charger;

FIG. 10 is a side view showing the insertion/removal of the USB 12V charger into the 12V port of the wall charger; and

FIG. 11 is a circuit block diagram of the wall charger.

### DETAILED DESCRIPTION

The present invention is described more fully hereinafter with reference to the accompanying drawings, in which various aspects of a wall charger are shown. This invention, however, may be embodied in many different forms and should not be construed as limited by the various aspects of the wall charger presented herein. The detailed description of the wall charger is provided below so that this disclosure will be thorough and complete, and will fully convey the scope of the present invention to those skilled in the art.

The detailed description may include specific details for illustrating various aspects of a wall charger. However, it will be apparent to those skilled in the art that the invention may be practiced without these specific details. In some instances, well known elements may be shown in block diagram form, or omitted, to avoid obscuring the inventive concepts presented throughout this disclosure.

Various aspects of a wall charger may be illustrated by describing components that are coupled together. As used herein, the term “coupled” is used to indicate either a direct connection between two components or, where appropriate, an indirect connection to one another through intervening or intermediate components. In contrast, when a component referred to as being “directly coupled” to another component, there are no intervening elements present.

Relative terms such as “lower” or “bottom” and “upper” or “top” may be used herein to describe one element's relationship to another element illustrated in the drawings. It will be understood that relative terms are intended to encompass different orientations of a wall charger in addition to the orientation depicted in the drawings. By way of example, if a wall charger in the drawings is turned over, elements described as being on the “bottom” side of the other elements would then be oriented on the “top” side of the other elements. The term “bottom” can therefore encompass both an orientation of “bottom” and “top” depending on the particular orientation of the apparatus.

Various aspects of a wall charger may be illustrated with reference to one or more exemplary embodiments. As used herein, the term “exemplary” means “serving as an example, instance, or illustration,” and should not necessarily be construed as preferred or advantageous over other embodiments of a wall charger disclosed herein.

The wall charger is compact and portable so that it can easily be stowed for transport, greatly enhancing a consumer's ability to use the wall charger to recharge or power one or more portable electronic devices (PEDs) that rely on a USB port for power and recharging. The wall charger is configured to provide up to two USB 5V ports for connecting to one or more PEDs when plugged into an AC circuit. A removable 12V charger may be disconnected from the 12V docking port and used separately to connect to a 12V DC circuit for use with generators or vehicles, for example, such as automobiles, trucks, and boats.

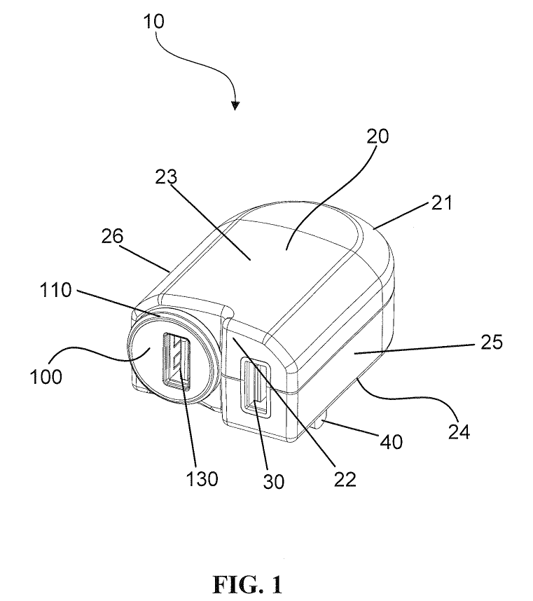

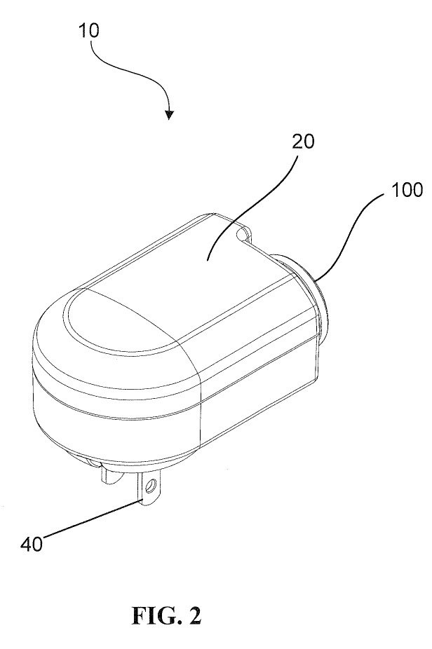

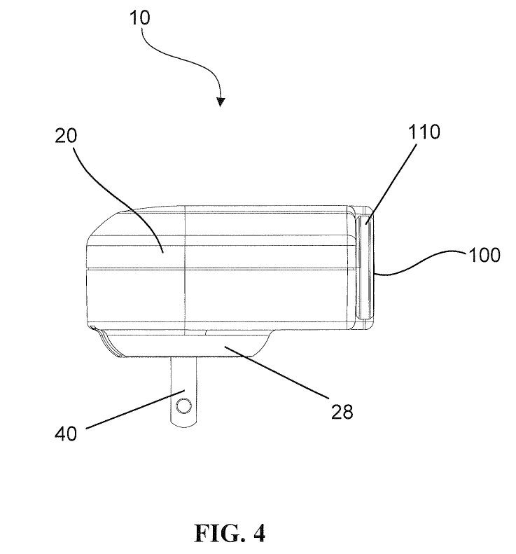

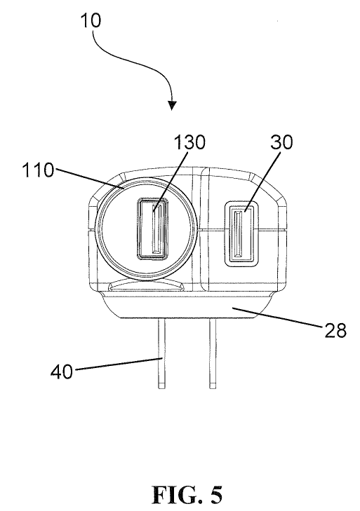

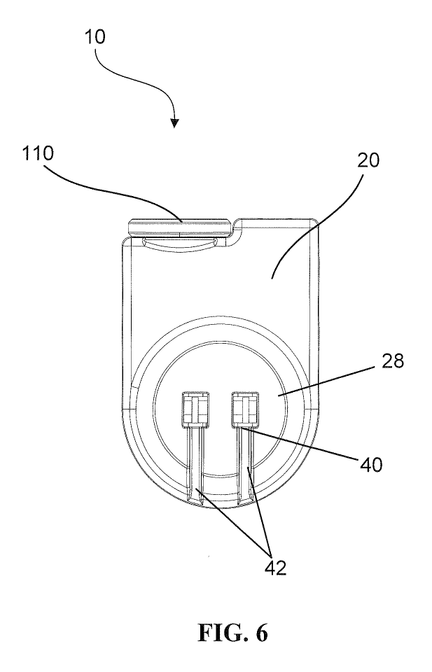

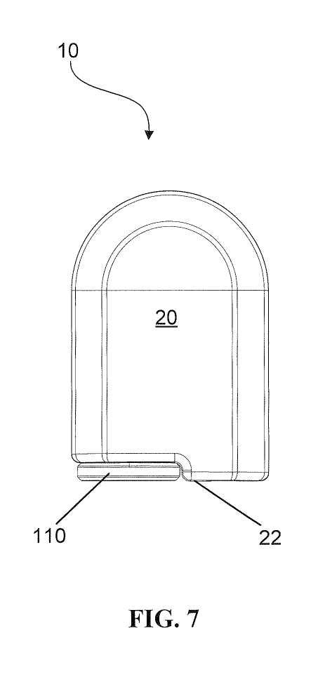

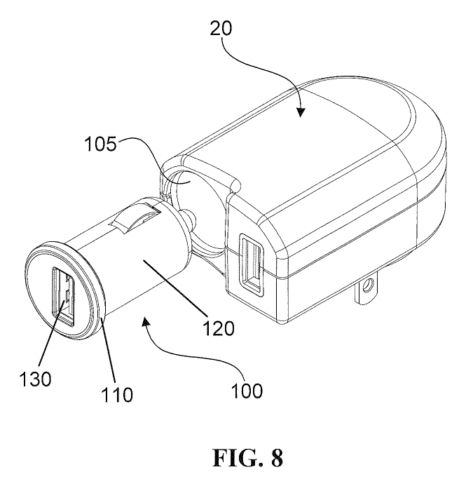

FIGS. 1-7 provide various views of a wall charger 10 configured to connect to an AC circuit and provide two USB 5V connection ports, 30 and 130. The wall charger 10 includes a body 20 and a removable 12V charger 100. The body 20 comprises a permanent USB 5V connection port 30 and a 12V DC docking port 105 (see FIG. 8). Prongs 40 are provided on a rear surface of the body 20 for plugging directly into an AC power source. As shown in FIG. 6, the prongs 40 may be collapsible and the body 20 may comprise prong channels 42 for seating the prongs 40 in a compact and unobtrusive manner, for example. Furthermore, although shown throughout the figures herein as having two prongs 40 that may, for example, collapse into prong channels 42, other features in accordance with aspects of the present invention may include, among others, three or more prongs, prongs arranged on different surfaces of the body, or prongs that are rotatable. The prongs 40 are connected to the electrical circuitry enclosed in the body (not shown) for providing a charging current to the 12 V docking port 105 and the permanent USB 5V connection port 30.

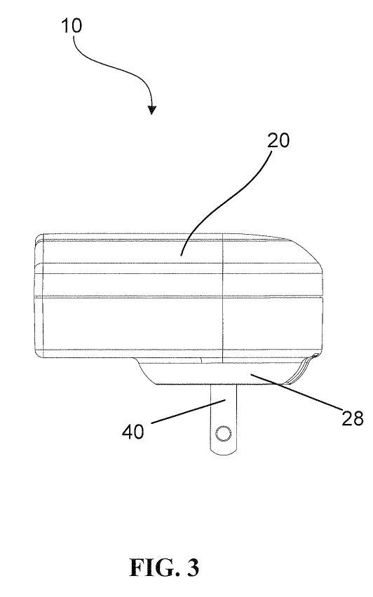

As shown in FIGS. 1-7, the wall charger 10 is formed so that when the collapsible prongs 40 are received into the body 20, or when the wall charger is plugged into a wall socket, the overall shape of the charger has the appearance of a jukebox, with an arched upper end 21 opposite a stepped port end 22 connected by a front surface 23 having beveled edges, a rear surface 24, and side surfaces 25 and 26. As shown in FIGS. 3-6, the rear surface 24 may be provided with a protruding surface 28. The protruding surface 28 serves as a spacer and may gently rise from the rear surface 28 with circular dimension, for example, to aesthetically match the geometric dimensions of the body 20. The body 20 may have an outer casing made of nonconductive material with a smooth finish, for example. The outer casing can be formed by a combination of two molded shells or any other method of forming an enclosure to house and protect the interior electrical circuitry for propagating the necessary electrical current from the AC power source to the 12 V docking port 105 and the permanent USB 5V connection port 30. The permanent USB 5V connection port 30 may be a USB Type A receptacle for receiving a USB Type A plug, but any suitable receptacle may be provided, including Type B, Mini-A and Mini-B, or Micro connectors, for example.

As shown in FIGS. 1, 4 and 7, the stepped port end 22 of the body 20 may be dimensioned so that the depth of the step matches the thickness of a mating flange 110 on the removable 12V charger 100 when the removable 12V charger 100 is fully inserted into the 12V DC docking port 105.

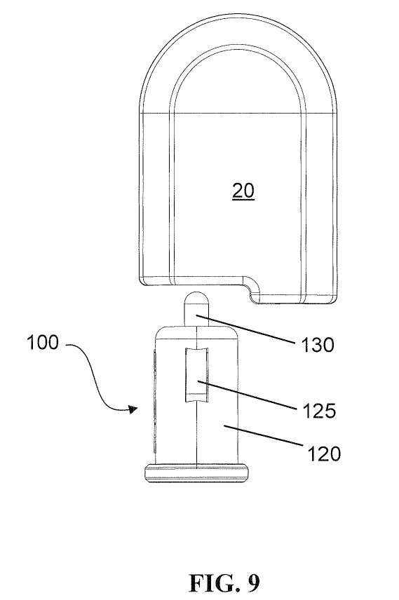

FIGS. 8-10 show the feature of the 12V removable charger 100 removed from the 12V DC docking port 105, in accordance with aspects of the present invention. The removable charger 100 may be formed with a tubular body 120 and the mating flange 110. The tubular body 120 may be cylindrical in shape and have an outer casing made of nonconductive material with a smooth finish, for example. The outer casing of the body 120 of the removable charger 100 can be formed by a combination of two molded shells or any other method of forming an enclosure to house and protect the interior electrical circuitry for propagating the necessary electrical current from the 12 V DC docking port 105 to the removable USB 5V connection port 130. The removable USB 5V connection port 130 may be a USB Type A receptacle for receiving a USB Type A plug, but any suitable receptacle may be provided, including Type B, Mini-A and Mini-B, or Micro connectors, for example.

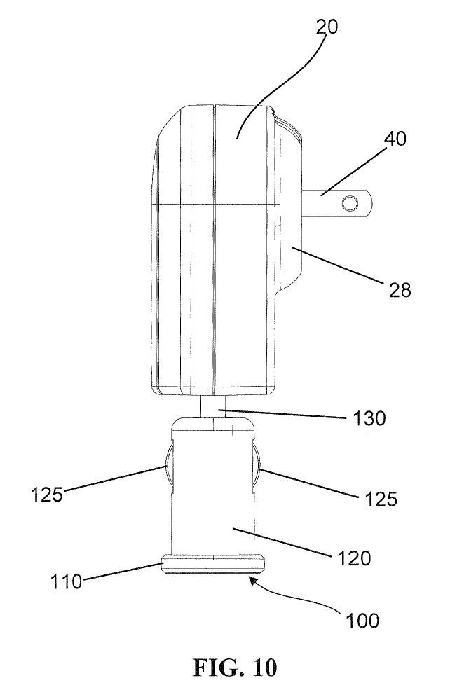

As shown in FIG. 10, the body 120 of the removable charger 100 may be provided with two side apertures to permit dual side ground contacts 125. A power tip 130 may extend from the insertion end of the body 120. The side ground contacts 125 and the power tip 130 may be spring loaded, for example, to ensure a tight, solid mechanical and electrical connection when the removable charger 100 is inserted and seated in the 12 V docking port 105.

Another variation in accordance with aspects of the present invention may be a Light Emitting Diode (LED) on one or both of the removable charger 100 and the body 20 to indicate that one or both of the USB 5V connection ports, 30 and 130, are receiving power. In another variation in accordance with aspects of the present invention, one or both of the removable charger 100 and the wall charger 10 may be provided with a built-in light. Light Emitting Diode (LED) technology, for example, may be used in the light because of the reduced current requirements and the lower level of lighting generally desirable in a light that may be used at night. But any soft glow lighting mechanism may be incorporated.

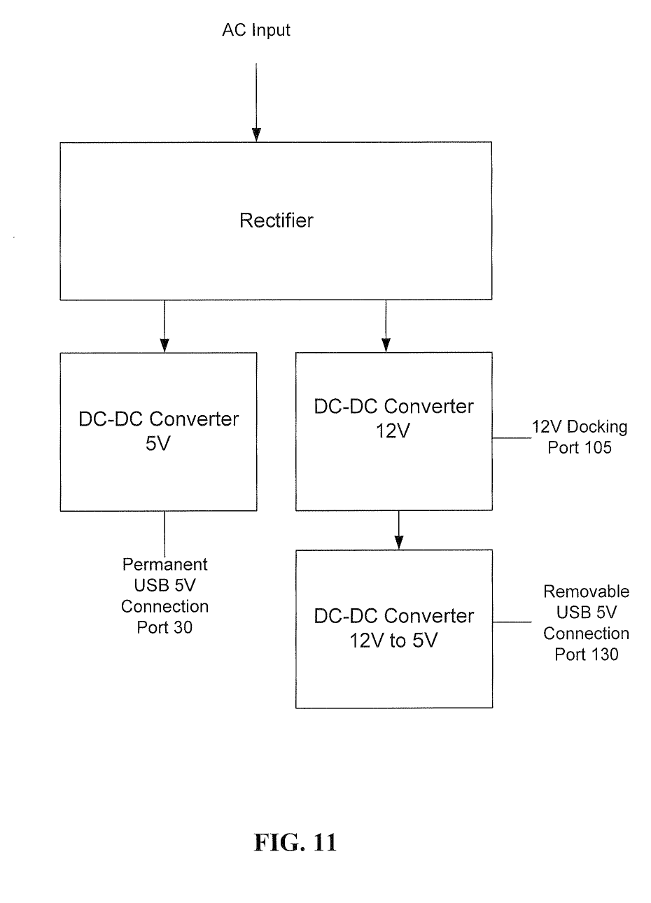

FIG. 11 provides a circuit block diagram illustrating the basic electrical components of the wall charger 10, including those of the separately removable charger 100. When the wall charger 10 is plugged into an AC outlet, a rectifier in the body 20 of the wall charger 10 converts the AC to DC for supplying current, preferably in the range of 1 Amp, to the USB 5V connection ports 30 and the 12V DC docking port 105. DC to DC converters are used to provide an output DC voltage to the permanent USB 5V connection port 30 of 5V and an output DC voltage to the 12V DC docking port 105 of 12V. A separate DC to DC converter is provided in the removable charger 100 so that when the charger is connected to the 12V DC docking port 105 of the wall charger 10, or any other 12V power source, an output DC voltage of 5V is provided to the removable USB 5V connection port 130.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A wall charger, comprising:
a body comprising;
at least one prong configured to be connected to an alternating current (AC) power source;
a Universal Serial Bus (USB) connection port configured to receive a USB plug, the USB connection port being electrically connected to said at least one prong; and
a docking port; and
a removable charger, wherein the docking port is configured to slidably receive the removable charger, the docking port being electrically connected to said at least one prong.

2. The wall charger of claim 1, wherein the body further comprises a channel, and wherein the at least one prong is configured to collapse into the channel.

3. The wall charger of claim 1, wherein the removable charger comprises a second USB connection port configured to receive a USB plug, the second USB connection port being electrically connected to said at least one prong.

4. The wall charger of claim 1, wherein the removable charger comprises at least one side ground contact and a power tip.

5. The wall charger of claim 4, wherein at least one of the at least one side ground contact and the power tip are spring loaded.

6. The wall charger of claim 1, wherein the body further comprises a rectifier that converts the AC and supplies a direct current (DC) to the USB connection port and the docking port.

7. The wall charger of claim 6, wherein the DC to the USB connection port has an output voltage of 5V.

8. The wall charger of claim 6, wherein the DC to the docking port has an output voltage of 12V.

9. The wall charger of claim 3, wherein the removable charger comprises a converter to provide a DC to the second USB connection port having an output voltage of 5V.

10. The wall charger of claim 1, wherein the removable charger comprises a mating flange that abuts a stepped surface of the body.

11. The wall charger of claim 1, further comprising a Light Emitting Diode (LED) to indicate when the USB connection port is receiving power.

12. The wall charger of claim 3, further comprising a LED to indicate when the second USB connection port is receiving power.

13. A method for charging at least one portable electronic device with a wall charger comprising a body having at least one prong configured to be connected to an alternating current (AC) power source, a Universal Serial Bus (USB) connection port configured to receive a USB plug, and a docking port, the USB connection port and the docking port being electrically connected to said at least one prong, the method comprising:
connecting said at least one prong to an AC power source; and
connecting a portable electronic device (PED) to the USB connection port.

14. The method of claim 13, wherein the wall charger further comprises a removable charger having a second USB connection port, the method further comprising:
slidably inserting the removable charger into the docking port, wherein the second USB connection port is electrically connected to said at least one prong.

15. The method of claim 13, further comprising:
connecting a second PED to the second USB connection port.

16. A method for supplying power to charge at least one portable electronic device (PED) through a Universal Serial Bus (USB) port comprising:
configuring a wall charger to connect to an alternating current (AC) power source, wherein the wall charger comprises at least one prong for connecting to the AC power source, a USB connection port configured to receive a USB plug, and a removable charger, the removable charger having a second USB connection port configured to receive a second USB plug; and
providing an electrical connection from the at least one prong to the USB connection port and the second USB connection port in the removable charger.

17. The method of claim 16, wherein the wall charger further comprises a docking port for mounting the removable charger to the wall charger.

18. The method of claim 17, further comprising:
providing a rectifier to supply a direct current (DC) to the USB connection port and the docking port.

19. The method of claim 18, wherein the DC to the USB connection port has an output voltage of 5V.

20. The method of claim 18, wherein the DC to the docking port has an output voltage of 12V.

21. The method of claim 20, further comprising:
providing a converter in the removable charger to supply a converted DC to the second USB connection port.

22. The method of claim 21, wherein the DC to the second USB connection port has an output voltage of 5V.

23. The method of claim 16, further comprising:
removing the removable charger from the wall charger; and
connecting the removable charger to a 12V DC circuit.
